(19) United States
(12) Patent Application Publication
(10) Pub. No.: US 2009/0181190 A1
(43) Pub. Date: Jul. 16, 2009

(54) THERMAL TRANSFER RECORDING MEDIUM

(75) Inventor: Yoshinori Tsubaki, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/353,558

(22) Filed: Jan. 14, 2009

(30) Foreign Application Priority Data
Jan. 16, 2008 (JP) 2008-007203

(51) Int. Cl. B41M 5/40

(52) U.S. Cl. 428/32.77

(57) ABSTRACT

A thermal transfer recording medium having at least one transferable protective layer arranged on a base with a non-transferable release layer provided therebetween, in which the protective layer is detached from the release layer at the interface between the at least one protective layer and the release layer during thermal transfer printing and then thermally transferred onto an image, includes a primer layer containing at least one fluorocarbon-based surfactant, the primer layer, the release layer, and the protective layer being stacked, in that order, on one surface of the base, in which the release layer has a glass transition temperature of 60° C. to 110° C.

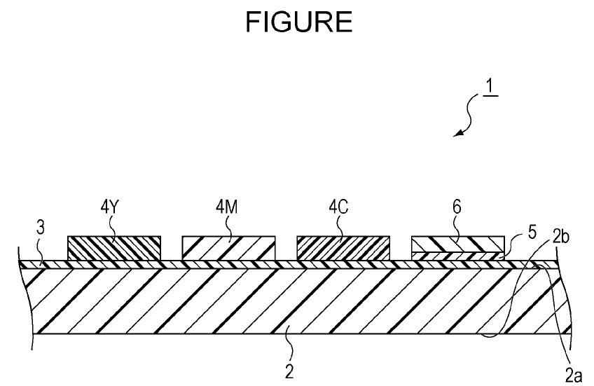

### CROSS REFERENCES TO RELATED APPLICATIONS

The present invention contains subject matter related to Japanese Patent Application JP 2008-007203 filed in the Japanese Patent Office on Jan. 16, 2008, the entire contents of which are incorporated herein by reference.

### BACKGROUND OF THE INVENTION

1. Field of the Invention

The present invention relates to thermal transfer recording media used in thermal transfer printing, and, in particular, to a thermal transfer recording medium configured to provide satisfactory glossiness on an image and satisfactory recording characteristics when a protective layer configured to protect the image is transferred.

2. Description of the Related Art

Hitherto, a technique for forming a color or monochrome image by allowing an ink sheet containing thermally diffusible coloring matter to face a coloring-matter-receiving layer of an image-receiving sheet such as a photographic paper, heating the thermally diffusible coloring matter with a thermal head, transferring the thermally diffusible coloring matter to the coloring-matter-receiving layer (i.e., a coloring-material thermal transfer method) has been used. Such a coloring-material thermal transfer method permits the formation of an image from digital data and has a reputation as a method providing half-toning comparable to that of silver halide photography without using a treatment solution such as a developing solution.

In the case where an image is formed on a dye-sublimation thermal transfer sheet containing sublimation dye, a gray-scale image such as a facial portrait image can be precisely formed. Unlike an image formed of common printing ink, however, the resulting image is formed of dye alone without a vehicle and thus disadvantageously has inferior durability, such as weatherability, abrasion resistance, and chemical resistance.

A method in which a thermal transfer sheet having a transferable protective layer is superposed on an image formed by thermal transfer of thermofusible ink or sublimation dye, the transferable protective layer is transferred with a thermal head or heating roller, and the protective layer is formed on the image has been employed. The arrangement of the protective layer on the image can improve durability, such as weatherability, abrasion resistance, and chemical resistance, and the degree of glossiness of the image to some extent.

In the thermal transfer sheet having the transferable protective layer, the protective layer is arranged on a base. The thermal transfer sheet is wound into an ink ribbon when the protective layer is not transferred. A certain degree of adhesive strength between the base and the protective layer is provided, thus preventing dusting the protective layer. When the protective layer is transferred by heating with a thermal head or the like, good transfer properties of the protective layer or good releasability of the protective layer from the base imparts glossiness. That is, in the thermal transfer sheet having the transferable protective layer, the protective layer is bonded to the base when the protective layer is not transferred, and the protective layer is easily detached from the base when the protective layer is transferred. This is a dilemma.

Japanese Unexamined Patent Application Publication No. 2007-176011 describes a thermal transfer sheet including a non-transferable release layer arranged between a base of a thermal transfer sheet and a protective layer in order to facilitate transfer of the transferable protective layer, the non-transferable release layer being configured to promote detachment of the protective layer from the base. The patent document also describes that the release layer is preferably composed of an organic-inorganic hybrid material.

In the method described in Patent Document 1, however, when the protective layer is transferred by heat from a thermal head, the difference in thermal deformation behavior among the base, the release layer, the protective layer, and the like and the difference in heat storage properties between an inorganic material and an organic material constituting the release layer lead to defectives on the image due to uneven transfer scanning of the protective layer in a subscanning direction of the thermal head, i.e., in the transport direction of the image receiving sheet such as a photographic paper.

Furthermore, Japanese Unexamined Patent Application Publication No. 2006-272960 describes an example of a thermal transfer sheet having a transfer layer composed of two polyester resins with relatively different molecular weights.

In the thermal transfer sheet, in particular, in the case where a back layer arranged on the back side of a base having a transferable protective layer contains thermofusible lubricant, such as phosphate or an aliphatic ester, the lubricant melted by heat from a thermal head when the protective layer is transferred flows in a stripe pattern in the subscanning direction of the thermal head while being hot. Thus, the thermal transfer sheet has another problem in which when heat is supplied with the thermal head to the protective layer from the back side of the base, thermal energy higher than thermal energy supplied is unevenly supplied to the protective layer in a stripe pattern, so that the transferred protective layer exhibits stripe-like pattern due to uneven glossiness, thereby leading to an uneven image.

### SUMMARY OF THE INVENTION

Accordingly, it is desirable to provide a thermal transfer recording medium in which a protective layer is bonded to a base when the protective layer is not transferred and in which the protective layer is easily detached from the base when the protective layer is transferred, so that the protective layer having satisfactory glossiness is transferred onto an image.

According to an embodiment of the present invention, there is provided a thermal transfer recording medium having at least one transferable protective layer arranged on a base with a non-transferable release layer provided therebetween, in which the protective layer is detached from the release layer at the interface between the at least one protective layer and the release layer during thermal transfer printing and then thermally transferred onto an image, includes a primer layer containing at least one fluorocarbon-based surfactant, the primer layer, the release layer, and the protective layer being stacked, in that order, on one surface of the base, in which the release layer has a glass transition temperature of 60° C. to 110° C.

When transfer is not performed, the fluorocarbon-based surfactant is present at the interface between the base and the release layer, thereby improving the adhesion between the base and the release layer. When transfer is performed, the fluorocarbon-based surfactant is diffused by thermal energy to the interface between the release layer and the protective layer, thereby facilitating detachment of the protective layer from the release layer. Thus, the detachment of the protective layer, i.e., dusting, when transfer is not performed can be prevented. When transfer is performed, the protective layer is easily detached from the release layer, thereby transfer the protective layer having uniform glossiness on an image.

### BRIEF DESCRIPTION OF THE DRAWING

FIGURE is a cross-sectional view of a thermal transfer recording medium according to an embodiment of the present invention.

### DESCRIPTION OF THE PREFERRED EMBODIMENTS

A thermal transfer recording medium according to an embodiment of the present invention will be described in detail with reference to the attached drawing.

As shown in FIGURE, a thermal transfer recording medium 1 includes a primer layer 3 arranged on one surface 2a of a base 2, the primer layer 3 being configured to adjust the applicability and adhesion of a yellow ink layer 4Y, a magenta ink layer 4M, and a cyan ink layer 4C, which contain coloring matter such as dye, and a protective layer 6 configured to protect an image to be formed. The three ink layers 4Y, 4M, and 4C and a non-transferable release layer 5 are aligned on the primer layer 3, the non-transferable release layer 5 being overlaid with the protective layer 6.

The thermal transfer recording medium 1 is mounted on a thermal transfer printing apparatus. The ink layers 4Y, 4M, and 4C are heated from the other surface 2b of the base 2 with a heater such as a thermal head to transfer the yellow, magenta, and cyan coloring matter to a thermal transfer image receiving sheet such as photographic paper transported into the thermal transfer printing apparatus, thereby forming a color image. The protective layer 6 is heated so as to be delaminated from the non-transferable release layer 5 and then is thermally transferred onto the resulting color image in order to protect the image.

Non-limiting examples of the base 2 of the thermal transfer recording medium 1 include plastic films, paper, synthetic paper, and cellophane. Preferably, the base 2 is formed of a thin film that can withstand a heating temperature of a heater such as a thermal head and has a high heat transfer coefficient and a uniform thickness, in such a manner that the ink layers 4Y, 4M, and 4C and the protective layer 6 are evenly heated.

Examples of the base 2 include unstretched or stretched films composed of, for example, polyethylene, polypropylene, polymethylpentene, polyethylene terephthalate, polyethylene naphthalate, polyamide, polyimide, polystyrene, polyvinyl chloride, polyvinylidene chloride, polyvinyl alcohol, ethylene-vinyl alcohol copolymers, polycarbonate, fluorocarbon resins, polymethyl methacrylate, polybutene-1, polyether ether ketone, polysulfone, polyether sulfone, and polyphenylene sulfide. Among these, the base 2 is preferably formed of a plastic film composed of polyethylene terephthalate, polyethylene naphthalate, or polyether ether ketone because the film has high resistance to heat and can be produced with only a slight nonuniformity in thickness. To secure adhesion of the plastic film to the ink layers 4Y, 4M, and 4C and the protective layer 6 arranged on the one surface 2a and to a heat-resistant slipping layer arranged on the other surface 2b described below, the plastic film is preferably subjected to surface treatment such as primer coating or corona discharge. Furthermore, to prevent adhesion of foreign matter and stabilize the travel of a sheet, the plastic film is preferably subjected to surface treatment such as anti-static treatment.

The base 2 preferably has a thickness of 3.5 to 12 μm and particularly preferably 4.0 to 6.0 μm. In the case of the base 2 having a thickness of 3.5 to 12 μm, the thermal transfer recording medium 1 has heat resistance, a step does not occur when the thermal transfer recording medium 1 is superposed on a thermal transfer image receiving sheet in order to thermally transfer coloring matter and the protective layer 6 to the sheet, and the reproducibility of the color tone is not reduced. Preferably, the base 2 has a breaking strength of 10 to 40 kg/mm² in both longitudinal and transverse directions and an elongation at break of 50% to 150% in both longitudinal and transverse directions (both according to JIS C2318). A breaking strength of 10 to 40 kg/mm² and an elongation at break of 50% to 150% do not cause stretching or breakage during winding and printing and are preferred.

To adjust the coatability and adhesion of the ink layers 4Y, 4M, and 4C and the protective layer 6, the base 2 is subjected to primer treatment to form the primer layer 3. In the primer treatment, resin surface modification, such as corona discharge, flame treatment, ozone treatment, ultraviolet ray treatment, radiation treatment, roughening, chemical processing, plasma treatment, or low-temperature plasma treatment, is performed over the whole of at least the one surface 2a of the base 2, and then a coating solution (primer layer coating solution) is applied. Alternatively, after a plastic film is formed by melt extrusion, a coating solution is applied onto the resulting unstretched film, and then the film is stretched to form the primer layer 3.

The primer layer 3 contains a resin and a specific fluorocarbon-based surfactant to improve the adhesion of the release layer 5 to the base 2 and the releasability of the protective layer 6 from the release layer 5.

Examples of a resin constituting the primer layer 3 include polyester-based resins, polyacrylic ester-based resins, polyurethane-based resins, styrene acrylate resins, ethyl cellulose, hydroxyethyl cellulose, ethylhydroxy cellulose, hydroxypropyl cellulose, methyl cellulose, cellulose acetate, and cellulose butyrate.

The fluorocarbon-based surfactant improves the adhesion of the release layer 5 to the base 2 when the protective layer 6 is not transferred, and facilitates detachment of the protective layer 6 from the release layer 5 when the protective layer 6 is thermally transferred.

In the primer layer 3, the fluorocarbon-based surfactant contained is present between the base 2 and the release layer 5 when the protective layer 6 is not transferred, thereby improving the adhesion between the base 2 and the release layer 5. Furthermore, in the primer layer 3 when the protective layer 6 is not transferred, the adhesion between the base 2 and the release layer 5 is improved by the fluorocarbon-based surfactant, and resin mixtures constituting the release layer 5 and the protective layer 6 and having different degrees of polarity have adhesion to each other. Thus, the protective layer 6 is not detached from the base 2, i.e., dusting can be inhibited. The fluorocarbon-based surfactant in the primer layer 3 is diffused into the release layer 5 by thermal energy applied from a thermal head when the protective layer 6 is thermally transferred. Then the fluorocarbon-based surfactant diffuses to the interface between the release layer 5 and the protective layer 6, thereby facilitating detachment of the protective layer 6 from the release layer 5 at the interface therebetween.

The fluorocarbon-based surfactant contains at least one selected from compounds of the formulae (1) to (3):

Rf-(L₁)ₘ-(Y₁)ₙ—X formula (1)

where Rf represents an aliphatic group containing at least one fluorine atom; L₁ represents a divalent linking group; Y₁ represents an optionally substituted alkyleneoxy group, alkylene group, or alkenyl group; X represents a hydrogen atom, a hydroxy group, an anionic group, or a cationic group; m represents zero or an integer of 1 to 5; and n represents zero or an integer of 1 to 40);

Rf—(O—Rf′)ₙ₁-L₂-X′ₘ₁ formula (2)

where Rf represents an aliphatic group containing at least one fluorine atom; Rf′ represents an alkylene group containing at least one fluorine atom; L₂ represents a simple bond or a linking group; X′ represents a hydroxy group, an anionic group, or a cationic group; and n1 and m1 each represent an integer of 1 or more); and

[(Rf″O)ₙ₂—(PFC)—CO—Y₂]ₖ-L₃-X″ₘ₂ formula (3)

where Rf″ represents a perfluoroalkyl group having 1 to 4 carbon atoms; (PFC) represents a perfluorocycloalkylene group; Y₂ represents a linking group containing an oxygen atom or a nitrogen atom; L₃ represents a simple bond or a linking group; X″ represents an anionic group, a cationic group, a nonionic group, or a water-solubility-imparting polar group containing an amphoteric group; n2 represents an integer of 1 to 5; k represents an integer of 1 to 3; and m2 represents an integer of 1 to 5).

In each of the formulae (1) and (2), Rf represents an aliphatic group containing at least one fluorine atom. The aliphatic group preferably has 1 to 18 carbon atoms, more preferably 2 to 12 carbon atoms, and particularly preferably 3 to 7 carbon atoms.

In the formula (1), L₁ represents a divalent linking group. The divalent linking group is particularly preferably a sulfonamide group, an alkylene oxide group, a phenoxy group, or an alkylenecarbonyl group.

In the formula (1), Y₁ represents an optionally substituted alkyleneoxy group or alkylene group. Examples of an alkyleneoxy group include an ethyleneoxy group and a propyleneoxy group. An ethyleneoxy group is particularly preferred. Examples of an alkylene group include a methylene group, an ethylene group, and a propylene group. An ethylene group is particularly preferred.

In the formula (1), X represents a hydrogen atom, a hydroxy group, an anionic group, or a cationic group. The anionic group is preferably a carboxy group, a sulfonic group, or a phosphate group. Preferred examples of a counter cation for the anionic group include alkali metal ions, such as a sodium ion and a potassium ion, and an ammonium ion. The cationic group is preferably a quaternary alkylammonium group. Preferred examples of a counter anion for the cationic group include halide ions and p-toluenesulfonic ions.

In the formula (1), m represents zero or an integer of 1 to 5. n represents zero or an integer of 1 to 40. It is particularly preferred that m represent zero and n represent 10 to 20.

In the formula (2), Rf′ represents an alkylene group containing at least one fluorine atom. The number of carbon atoms in the alkylene group is preferably in the range of 1 to 8 and more preferably 2 to 5. Particularly preferably, the number of carbon atoms is 2 or 3.

In the formula (2), L₂ represents a simple bond or a linking group. The linking group is preferably an alkylene group, an arylene group, or a divalent linking group containing a heteroatom.

In the formula (2), X′ represents a hydroxy group, an anionic group, or a cationic group. The anionic group is preferably a carboxy group, a sulfonic group, or a phosphate group. Preferred examples of a counter cation for the anionic group include alkali metal ions, such as a sodium ion and a potassium ion, and an ammonium ion. The cationic group is preferably a quaternary alkylammonium group. Preferred examples of a counter anion for the cationic group include halide ions and p-toluenesulfonic ions.

In the formula (2), n1 and m1 each represent an integer of 1 or more. It is preferred that n1 represent 1 to 10 and m1 represent 1 to 3.

In the formula (3), Rf″ represents a perfluoroalkyl group having 1 to 4 carbon atoms. The perfluoroalkyl group is particularly preferably a trifluoromethyl group.

In the formula (3), (PFC) represents a perfluorocycloalkylene group. Examples of the perfluorocycloalkylene group include a perfluorocyclooctylene group, a perfluorocycloheptylene group, a perfluorocyclohexylene group, and a perfluorocyclopentylene group. A perfluorocyclohexylene group is particularly preferred.

In the formula (3), Y₂ represents a linking group containing an oxygen atom or a nitrogen atom. The linking group is particularly preferably —OCH₂— or —NHCH₂—.

In the formula (3), L₃ represents a simple bond or a linking group. Examples of the linking group include polyvalent, typically, divalent linking groups, such as substituted and unsubstituted alkylenes (e.g., ethylene, n-propylene, and isobutylene), arylenes (e.g., phenylene), combinations of alkylenes and arylenes (e.g., xylylene), oxydialkylenes (e.g., CH₂CH₂OCH₂CH₂), and thiodialkylenes (e.g., CH₂CH₂SCH₂CH₂).

In the formula (3), X″ represents an anionic group, a cationic group, a nonionic group, or a water-solubility-imparting polar group containing an amphoteric group. Examples of the anionic group include CO₂H, CO₂M, SO₃H, SO₃M, OSO₃H, OSO₃M, (OCH₂CH₂)OSO₃M, OPO(OH)₂, and OPO(OM)₂ (wherein M represents a metal ion, such as a sodium ion, a potassium ion, or a calcium ion, or an ammonium ion). Among these, a carboxyl group, a sulfonic group, and a phosphate group are preferred. Preferred examples of a counter cation for the anionic group include alkali metal ions, such as a sodium ion and a potassium ion, and an ammonium ion. The cationic group is preferably a quaternary alkylammonium group. Preferred examples of a counter anion for the cationic group include halide ions and p-toluenesulfonic ions. The nonionic group is preferably a hydroxy group.

In the formula (3), n2 represents an integer of 1 to 5. k represents an integer of 1 to 3. m2 represents an integer of 1 to 5. n2 preferably represents 3. k preferably represents 1 or 2. m2 preferably represents 1.

While specific examples of the fluorocarbon-based surfactant that can be used in the present invention will be described below, the fluorocarbon-based surfactant is not limited thereto. Any of the fluorocarbon-based surfactants represented by the formulae (1) to (3) may be used.

Examples of the fluorocarbon-based surfactant of the formula (1) are as follows:
1-1. C₈F₁₇SO₃K
1-2. C₈F₁₇SO₃Li
1-3. C₈F₁₇COONH₄
1-4. C₈F₁₇COOK
1-5. C₉F₁₉—O—C₆H₄—SO₃K
1-6. C₉F₁₉—O—C₆H₄—SO₃Na
1-7. C₆F₁₃—O—C₆H₄—SO₃K
1-8. C₆F₁₃—O—C₆H₄—SO₃Na
1-9. C₇F₁₅COONH₄
1-10. NaO₃S (CH(CHCOOCH₂CH₂C₈F₁₇)COOCH₂CH₂C₈F₁₇)
1-11. C₈F₁₇SO₂N(C₃H₇)(CH₂COOK)
1-12. C₈F₁₇SO₂N(C₃H₇)(CH₂CH₂OPO₃Na₂)
1-13. C₈F₁₇SO₂N(C₁₂H₂₅)((C₂H₄O)₄C₄H₈SO₃Na)
1-14. C₆F₁₃CH₂CH₂SO₃NH₄
1-15. CF₃CF₂(CF₂CF₂)₃CH₂CH₂SO₃NH₄
1-16. CF₃CF₂(CF₂CF₂)₄CH₂CH₂SO₃NH₄
1-17. C₆F₁₃CH₂CH₂O—PO(ONH₄)₂
1-18. C₆F₃CH₂CH₂O—PO(ONH₄)(OCH₂CH₂OH)
1-19. C₂F₅(CH₂)₆SO₃NH₄
1-20. C₃F₇(CH₂)₅SO₃NH₄
1-21. C₂F₅(CH₂)₆COOLi
1-22. C₃F₇(CH₂)₃O—C₆H₄—SO₃K
1-23. NaO₃S(CH(CHCOO(CH₂)₉C₃F₇)COO(CH₂)₉C₃F₇)
1-24. C₃F₇(CH₂)₅SO₂N(C₃H₇)(CH₂COOK)
1-25. C₃F₇(CH₂)₅SO₂N(C₁₂H₂₅)((C₂H₄O))₄C₄H₈SO₃Na)
1-26. (C₂F₅CH₂O)₂PO(OH)₂
1-27. C₃F₇CH₂CH₂OPO(OH)₂
1-28. C₃F₇CH₂CH₂SCH₂CH₂COOLi
1-29. C₆F₁₃CH₂CH₂SCH₂CH₂COOLi
1-30. (C₆F₁₃CH₂CH₂O)₂PO(OH)₂
1-31. C₆F₁₃CH₂CH₂O—(CH₂CH₂O)₁₀—H
1-32. C₈F₁₇CH₂CH₂O—(CH₂CH₂O)₁₂—H
1-33. C₁₀F₂₁CH₂CH₂O—(CH₂CH₂O)₈—H
1-34. C₄F₉CH₂CH₂O—(CH₂CH₂O)₂₀—H
1-35. C₃F₇CH₂CH₂O—(CH₂CH₂O)₁₀—H
1-36. C₃F₇CH₂CH₂O—(CH₂CH₂O)₁₂—H
1-37. C₂F₅CH₂CH₂O—(CH₂CH₂O)₁₅—H
1-38. C₃F₇—(CH₂CH₂O)₂—(CH₂C(OH)H—CH₂O)₁₀—H
1-39. C₄F₉—CH(CH₃)CH₂O—(CH₂CH₂O)₉—H
1-40. C₆F₁₃—(CH₂CH₂O)₃—(CH₂C(OH)H—CH₂O)₁₂—H
1-41. C₃F₇CH₂CH₂O—(CH₂CH₂O)₃₁—H

Examples of the fluorocarbon-based surfactant of the formula (2) are as follows:
2-1. C₅F₁₁(OCF₂)OPO(ONa)₂
2-2. HC₆F₁₂(OCF₂)OPO(ONa)₂
2-3. C₈F₁₇ (OCF₂)OPO(ONa)₂
2-4. C₁₀F₂₁(OCF₂)OPO(ONa)₂
2-5. C₁₂F₂₅ (O—CF₂)OPO(ONa)₂
2-6. C₃F₇(OC₂F₄)OPO(ONa)₂
2-7. C₄F₉(OC₂F₄)OPO(ONa)₂
2-8. C₅F₁₁(OC₂F₄)OPO(ONa)₂
2-9. H—C₆F₁₂—(OC₂F₄)—OPO(ONa)₂
2-10. C₇F₁₅(OC₂F₄)OPO(ONa)₂
2-11. C₉F₁₉(OC₂F₄)OPO(ONa)₂
2-12. C₁₁F₂₃(OC₂F₄)OPO(ONa)₂
2-13. C₃F₇(OCF₂)₆OPO(ONa)₂
2-14. C₄F₉(OCF₂)₆OPO(ONa)₂
2-15. C₅F₁₁—(O—CF₂)₅—O—PO(ONa)₂
2-16. H—C₆F₁₂—(OCF₂)₃OPO(ONa)₂
2-17. C₃F₇O(CF₂)₃COONa
2-18. C₄F₉O(CF₂)₃COONa
2-19. C₅F₁₁O(CF₂)₃COONa
2-20. H—C₇F₁₄—[O(CF₂)₃]—OCH(COONa)₂
2-21. C₈F₁₇O(CF₂)₃OCH(COONa)₂
2-22. C₃F₇O(CF₂)₅COONa
2-23. C₄F₉O(CF₂)₅COONa
2-24. C₅F₁₁O(CF₂)₅COONa
2-25. C₇F₁₅O(CF₂)₅COONa
2-26. C₃F₇ (OC₂F₄)₅COONa
2-27. C₄F₉(OC₂F₄)₂COONa
2-28. C₅F₁₁—(O—C₂F₄)₂—COONa
2-29. H—C₇F₁₄(OC₂F₄)₂COONa
2-30. C₉F₁₉(OC₂F₄)₂COONa
2-31. C₂F₅(OC₂F₄)₃COONa
2-32. C₂F₅(OC₂F₄)₅COONa
2-33. C₃F₇(OC₂F₄)₄COONa
2-34. C₄F₉(OC₂F₄)₃COONa
2-35. C₅F₁₁(OC₂F₄)₃NHCOCH(COONa)₂
2-36. H—C₆F₁₂(OC₂F₄)₃NHCOCH(COONa)₂
2-37. C₄F₉(OC₂F₄)₂OCF₂COONa
2-38. C₅F₁₁(OC₂F₄)₂OCF₂COONa
2-39. C₇F₁₅(OC₂F₄)₂OCF₂COONa
2-40. C₄F₉—OCF₂—[O(CF₂)₅]—COOK
2-41. C₅F₁₁—OCF₂—[O(CF₂)₅]—COOK
2-42. H—C₆F₁₂—OCF₂—[O(CF₂)₅]—COOK
2-43. C₄F₉—(OC₂F₄)₅—[O(CF₂)₃]—COOK
2-44. C₅F₁₁—(OC₂F₄)₂—[O(CF₂)₃]—COOK
2-45. C₆F₁₃—(OC₂F₄)₂—[O—(CF₂)₃]—COOK
2-46. C₁₂F₂₅OCF₂OSO₃Na
2-47. C₇F₁₅OC₂F₄OC₃H₆SO₃Na
2-48. C₄F₉—(OCF₂)₆—OSO₃Na
2-49. H—C₅F₁₀—(OCF₂)₅—OC₃H₆SO₃Na
2-50. H—C₆F₁₂—(OCF₂)₃—OSO₃Na
2-51. C₅F₁₁—(OC₂F₄)₂—OC₃H₆SO₃Na
2-52. C₇F₁₅—(OC₂F₄)₂—OSO₃Na
2-53. C₃F₇—(OC₂F₄)₄—OC₃H₆—SO₃Na
2-54. C₄F₉—(OC₂F₄)₃—O—SO₃Na
2-55. H—C₅F₁₀—(OC₂F₄)₃—OC₃H₆—SO₃Na
2-56. C₅F₁₁OCF₂—[O(CF₂)₅]—OSO₃Na
2-57. C₄F₉—(OC₂F₄)₂—[O(CF₂)₃]—OSO₃Na
2-58. (HCF₂)₃C—(OC₂F₄)₃—OSO₃Na
2-59. (CF₃)₂CFCF₂CF₂—(OCF₂)₅—OC₃H₆—SO₃Na
2-60. C₁₁F₂₃(OC₂F₄)OSO₃Na
2-61. C₄F₉—(OC₂F₄)₃—NHCO—(CH₂)₃—N⁺(CH₃)₃.Br⁻
2-62. C₅F₁₁—(OC₂F₄)₂—NHCO—(CH₂)₃—N⁺(CH₃)₃.Br⁻
2-63. HC₆F₁₂—(OC₂F₄)₂—NHCO—(CH₂)₃—N⁺(CH₃)₃.Br⁻
2-64. C₄F₉—(OC₂F₄)₃—OCH₂—N⁺(CH₃)₂(C₂H₄OH).Br⁻
2-65. C₅F₁₁—(OC₂F₄)₂—OCH₂—N⁺(CH₃)₂(C₂H₄OH).Br⁻
2-66. HC₆F₁₂—(OC₂F₄)₂—OCH₂—N⁺(CH₃)₂(C₂H₄OH).Br⁻
2-67. C₅F₁₁—OCF₂—(OC₂F₄)—NHCO—(CH₂)₃—N⁺(CH₃)₃.Br⁻
2-68. (CF₃)₃C—(OC₂F₄)₃—OCH₂—N⁺(CH₃)₂(C₂H₄OH).Br⁻
2-69. C₁₂F₂₅OCF₂OH
2-70. C₇F₁₅OC₂F₄OH
2-71. C₄F₉—(OCF₂)₆—OC₃H₆OH
2-72. C₅F₁₁—(OCF₂)₅—OC₃H₆OH
2-73. HC₆F₁₂—(OCF₂)₃—OH
2-74. C₅F₁₁—(OC₂F₄)₂—OC₃H₆OH
2-75. C₇F₁₅—(OC₂F₄)₂—OC₃H₆OH
2-76. C₃F₇—(OC₂F₄)₄—OC₃H₆OH
2-77. HC₄F₈—(OC₂F₄)₃—OC(C₂H₄OH)₃
2-78. C₅F₁₁—(OC₂F₄)₃—OC₃H₆OH
2-79. C₅F₁₁OCF₂O(CF₂)₅OH
2-80. C₄F₉—(OC₂F₄)₂—O(CF₂)₃OH
2-81. (CF₃)₃C—(OC₂F₄)₃—OH
2-82. (HCF₂)₂CFCF₂CF₂—(OCF₂)₅—OH
2-83. C₁₁F₂₃(OC₂F₄)₄OH

The foregoing compounds of the formula (2) can be synthesized based on methods described in PCT Japanese Translation Patent Publication Nos. 10-500950 and 11-50436.

Examples of the fluorocarbon-based surfactant of the formula (3) are as follows:
3-1. (CF₃O)₃—(PFC)—CONHC₃H₆N⁺(CH₃)₂C₂H₄COO⁻
3-2. (CF₃O)₃—(PFC)—CONHC₃H₆N⁺(CH₃)₂C₂H₄SO₃⁻
3-3. (CF₃O)—(PFC)—CONHC₃H₆N⁺(CH₃)₂C₂H₄SO₃⁻
3-4. (CF₃O)₃—(PFC)—CON(C₃H₆SO₃—)C₃H₆N⁺(CH₃)₂H
3-5. (CF₃O)—(PFC)—CON(C₃H₆SO₃—)C₃H₆N⁺(CH₃)₂H
3-6. [(CF₃O)₃—(PFC)—COOCH₂]₂CH—CONHC₃H₆N⁺(CH₃)₂C₂H₄SO₃⁻
3-7. [(CF₃O)₂—(PFC)—COOCH₂]₂CH—CONHC₃H₆N⁺(CH₃)₂C₂H₄SO₃⁻
3-8. [(CF₃O)—(PFC)—COOCH₂]₂CH—CONHC₃H₆N⁺(CH₃)₂C₂H₄SO₃⁻
3-9. (CF₃O)₃—(PFC)—CONHC₃H₆N⁺(CH₃)₂C₂H₄OH.Cl⁻
3-10. (CF₃O)₂—(PFC)—CONHC₃H₆N⁺(CH₃)₂C₂H₄OH.Cl⁻
3-11. (CF₃O)—(PFC)—CONHC₃H₆N⁺(CH₃)₂C₂H₄OH.Cl⁻
3-12. (CF₃O)₃—(PFC)—CONHC₃H₆N⁺(CH₃)₂H.Cl⁻
3-13. (CF₃O)₂—(PFC)—CONHC₃H₆N⁺(CH₃)₂H.Cl⁻
3-14. (CF₃O)—(PFC)—CONHC₃H₆N⁺(CH₃)₂H.Cl⁻
3-15. [(CF₃O)₃—(PFC)—COOCH₂]₂C(CH₃)N⁺(CH₃)₂H.Cl⁻
3-16. [(CF₃O)₂—(PFC)—COOCH₂]₂C(CH₃)N⁺(CH₃)₂H.Cl⁻
3-17. [(CF₃O)—(PFC)—COOCH₂]₂C(CH₃)N⁺(CH₃)₂H.Cl⁻
3-18. [(CF₃O)₃—(PFC)—COOCH₂]₂CHC₃H₆N⁺(CH₃)₂H.Cl⁻
3-19. [(CF₃O)₂—(PFC)—COOCH₂]₂CHC₃H₆N⁺(CH₃)₂H.Cl⁻
3-20. [(CF₃O)—(PFC)—COOCH₂]₂CHC₃H₆N⁺(CH₃)₂H.Cl⁻
3-21. (CF₃O)3—(PFC)—COO(C₂H₄O)₁₂H
3-22. (CF₃O)₂—(PFC)—COO(C₂H₄O)₁₂H
3-23. (CF₃O)—(PFC)—COO(C₂H₄O)₁₂H
3-24. (CF₃O)₃—(PFC)—COO(C₂H₄O)₁₅CH₃
3-25. (CF₃O)₂—(PFC)—COO(C₂H₄O)₁₅CH₃
3-26. (CF₃O)—(PFC)—COO(C₂H₄O)₁₅CH₃
3-27. [(CF₃O)₃—(PFC)—COOCH₂]₂CHC₃H₆OH
3-28. [(CF₃O)₂—(PFC)—COOCH₂]₂CHC₃H₆OH
3-29. [(CF₃O)—(PFC)—COOCH₂]₂CHC₃H₆OH
3-30. (CF₃O)₃—(PFC)—CONHC₃H₆COONa
3-31. (CF₃O)₂—(PFC)—CONHC₃H₆COONa
3-32. (CF₃O)—(PFC)—CONHC₃H₆COOK
3-33. (CF₃O)₃—(PFC)—CONHC₃H₆SO₃Na
3-34. (CF₃O)₂—(PFC)—CONHC₃H₆SO₃Na
3-35. (CF₃O)—(PFC)—CONHC₃H₆SO₃K
3-36. (CF₃O)₃—(PFC)—CON(C₃H₆SO₃Na)C₃H₇
3-37. (CF₃O)₂—(PFC)—CON(C₃H₆SO₃Na)C₃H₇
3-38. (CF₃O)—(PFC)—CON(C₃H₆SO₃Na)C₃H₇
3-39. [(CF₃O)₃—(PFC)—COOCH₂]₂C(CH₃)COONa
3-40. [(CF₃O)₂—(PFC)—COOCH₂]₂C(CH₃)COONa
3-41. [(CF₃O)—(PFC)—COOCH₂]₂C(CH₃)COONa
3-42. [(CF₃O)₃—(PFC)—COOCH₂]₂C(COONa)₂
3-43. [(CF₃O)₂—(PFC)—COOCH₂]₂C(COONa)₂
3-44. [(CF₃O)—(PFC)—COOCH₂]₂C(COONa)₂
3-45. [(CF₃O)₃13 (PFC)—COOCH₂]₂C(CH₃)SO₃Na
3-46. [(CF₃O)₂—(PFC)—COOCH₂]₂C(CH₃)SO₃Na
3-47. [(CF₃O)—(PFC)—COOCH₂]₂C(CH₃)SO₃Na
3-48. [(CF₃O)₃—(PFC)—COOCH₂]₂CHC₃H₆SO₃Na
3-49. [(CF₃O)₂—(PFC)—COOCH₂]₂CHC₃H₆SO₃Na
3-50. [(CF₃O)—(PFC)—COOCH₂]₂CHC₃H₆SO₃Na

In the fluorocarbon-based surfactant of the formula (3), (PFC) represents a perfluorocyclohexylene group. When three (CF₃O) groups are attached, the (CF₃O) groups are located at the 3-, 4-, and 5-positions with respect to the carbonyl group positioned at the 1-position. When two (CF₃O) groups are attached, the (CF₃O) groups are located at the 3- and 4-positions. When one (CF₃O) group is attached, the (CF₃O) group is located at the 4-position.

The foregoing compounds of the formula (3) can be synthesized based on methods described in Japanese Unexamined Patent Application Publication No. 10-158218 and PCT Japanese Translation Patent Publication No. 2000-505803.

Examples of commercially available fluorocarbon-based surfactants that can be preferably used in the present invention include Ftergent 100C, Ftergent 150, Ftergent 250, Ftergent 300, and Ftergent 400SW (produced by Neos Co., Ltd.); Novec HFE, Novec EGC-1700, and Novec 1720 (produced by Sumitomo 3M Limited); and Zonyl and Zonyl FS (produced by Du Pont Kabushiki Kaisha).

The fluorocarbon-based surfactant contained in the primer layer 3 preferably has a sulfobetaine structure or an anionic structure because the fluorocarbon-based surfactant is readily thermally diffused by heat applied when the protective layer 6 is thermally transferred. The fluorocarbon-based surfactant accounts preferably for about 0.01% to about 3% of the solid content of the primer layer 3. In the case where the proportion of the fluorocarbon-based surfactant is 0.01% to 3% of the solid content of the primer layer 3, a satisfactory adhesion between the base 2 and the release layer 5 is provided when thermal transfer is not performed, and the detachment of the protective layer 6 is facilitated when thermal transfer is performed.

The primer layer 3 may be formed by applying a primer layer coating solution containing a resin and the fluorocarbon-based surfactant dissolved or dispersed in a solvent onto at least the one surface 2a of the base 2 by a coating technique used in the related art, for example, gravure coating, roll coating, screen printing, or reverse-roll coating with a photogravure cylinder, followed by drying.

The ink layers 4Y, 4M, and 4C arranged on the primer layer 3 mainly contain different dyes as coloring matter and a binder resin configured to support the dyes. The coloring matter contained in the ink layers 4Y, 4M, and 4C is not limited to sublimation dye but may be thermofusible coloring matter.

Examples of dye include methine dyes, such as diarylmethane and thiazole dyes; azomethine dyes, such as indoaniline, acetophenoneazomethine, imidazoleazomethine, and pyridoneazomethine dyes; xanthene dyes; oxazine dyes; cyanomethylene dyes such as dicyanostyrene dyes; azine dyes; tahiazine dyes; azo dyes, such as benzeneazo, pyridoneazo, isothiazoleazo, imidazoleazo, pyrraoleazo, disazo, and triazoleazo dyes; naphthoquinone dyes; anthraquinone dyes; quinophthalone dyes; and rhodamine lactam dyes.

Examples thereof include Color Index (C.I.) Disperse Yellows 3, 7, 23, 51, 54, 60, 79, and 141, C.I. Disperse Blues 14, 19, 24, 26, 56, 287, 301, and 354, C.I. Disperse Reds 1, 59, 60, 73, 135, and 167, C.I. Disperse Violets 4, 13, 26, 31, 36, and 56, C.I. Disperse Orange 149, C.I. Solvent Yellows 14, 16, 29, 56, and 201, C.I. Solvent Blues 11, 35, 36, 49, 50, 63, 97, and 105, C.I. Solvent Reds 18, 19, 23, 24, 25, 81, 143, and 182, C.I. Solvent Violet 13, C.I. Solvent Green 3, and C.I. Solvent Black 3.

Each of the dye contents of coating solutions configured to form the ink layers is preferably in the range of 5% to 90% by weight and more preferably 10% to 70% by weight with respect to the total amount of all components constituting a corresponding one of the ink layers 4Y, 4M, and 4C.

Any binder resin used in ink layers of thermal transfer recording media in the related art can be used as the binder resin configured to support the dyes. Examples of the binder resin include cellulosic resins, such as cellulose adducts, cellulose esters, and cellulose ethers; polyvinyl acetals, such as polyvinyl alcohol, polyvinyl formal, polyvinyl acetoacetal, and polyvinyl butyral; vinyl resins such as polyvinylpyrrolidone, polyvinyl acetate, polyvinyl acetate-polyvinyl chloride copolymers, polyacrylamide, styrene resins, poly(meth)acrylate, poly(meth)acrylic acid, and (meth)acrylic acid copolymers; gum resins; ionomer resins; olefin resins; and polyester resins. Among these binder resins, polyvinyl butyral, polyvinyl acetoacetal, and cellulosic resins are preferred because of their excellent shelf life.

Examples of the binder resin contained in the ink layers 4Y, 4M, and 4C further include reaction products of isocyanates and active hydrogen-containing compounds selected from polyvinyl butyral, polyvinyl formal, polyester polyol, and acrylic polyol, reaction products of the isocyanates selected from diisocyanates and triisocyanates and the active hydrogen-containing compounds, and reaction products of 10 to 200 parts by mass of the isocyanates and 100 parts by mass of the active hydrogen-containing compounds, which are described in Japanese Examined Patent Application Publication No. 5-78437;

organic solvent-soluble polymers prepared by esterification and/or a urethane-bond-forming reaction of intramolecular hydroxy groups of naturally occurring and/or semisynthetic water-soluble polymers, and naturally occurring and/or semisynthetic water-soluble polymers;

cellulose acetate having a degree of acetylation of 2.4 or more and a total degree of substitution of 2.7 or more described in Japanese Unexamined Patent Application Publication No. 3-264393;

vinyl resins, such as polyvinyl alcohol (Tg: 85° C.), polyvinyl acetate (Tg: 32° C.), and vinyl chloride/vinyl acetate copolymers (Tg: 77° C.); polyvinyl acetal resins, such as polyvinyl butyral (Tg: 84° C.) and polyvinyl acetoacetal (Tg: 110° C.); vinyl resins such as polyacrylamide (Tg: 165° C.); and polyester resins such as aliphatic polyesters (Tg: 130° C.);

reaction products of isocyanates and polyvinyl butyral having a vinyl alcohol moiety content of 15% to 40% by mass, and reaction products of the isocyanates selected from the diisocyanates and triisocyanates and the polyvinyl butyral, which are described in Japanese Unexamined Patent Application Publication No. 7-52564;

phenyl isocyanate-modified polyvinyl acetal resins of the formula (I) described in Japanese Unexamined Patent Application Publication No. 7-32742;

cured products of compositions each containing one selected from isocyanate-reactive cellulose and isocyanate-reactive acetal resins, one selected from isocyanate-reactive acetal resins, isocyanate-reactive vinyl resins, isocyanate-reactive acrylic resins, isocyanate-reactive phenoxy resins, and isocyanate-reactive polystyrene, and a polyisocyanate compound described in Japanese Unexamined Patent Application Publication No. 6-155935;

polyvinyl butyral resins (preferably having a molecular weight of 60,000 or more, a glass transition temperature of 60° C. or higher and more preferably 70° C. to 110° C., and a vinyl alcohol moiety content of 10% to 40% by mass and more preferably 15% to 30%); and

acrylic-modified cellulosic resins. Examples of the cellulosic resins include ethyl cellulose, hydroxyethyl cellulose, ethylhydroxy cellulose, hydroxypropyl cellulose, methyl cellulose, cellulose acetate, and cellulose acetate butyrate (preferably, ethylcellulose).

These binder resins may be used alone or in combination.

The release layer 5 configured to achieve satisfactory releasability of the protective layer 6 is located between the base 2 provided with the primer layer 3 and the protective layer 6. The release layer 5 is arranged so as to adjust the adhesion between the protective layer 6 and the base 2 to successfully detach the protective layer 6 when the releasability of the protective layer 6 from the base 2 is not adequate. In general, such a release layer facilitates the separation between the base 2 and the release layer 5 or between the release layer 5 and the protective layer 6. In the thermal transfer recording medium 1, the release layer 5 facilitates separation at the interface between the release layer 5 and the protective layer 6.

Examples of a material constituting the release layer 5 include various waxes such as silicone wax; various resins, such as silicone resins, fluorocarbon resins, acrylic resins, water-soluble resins, cellulose derivative resins, urethane resins, vinyl acetate resins, polyvinyl acetal resins, acrylic vinyl ether resins, and maleic anhydride resins; and mixtures thereof. The release layer 5 is preferably composed of a polyvinyl acetal resin from the viewpoint of achieving good recording properties.

The release layer 5 is composed of the foregoing resin with a glass transition temperature of 60° C. to 110° C. A glass transition temperature of the resin constituting the release layer 5 of 60° C. or higher results in the suppression of the diffusion of the fluorocarbon-based surfactant contained in the primer layer 3 into the release layer 5 and allows the fluorocarbon-based surfactant to stay in the primer layer 3 when the protective layer 6 is not thermally transferred; hence, the dusting, i.e., detachment, of the protective layer 6 is preferably inhibited. A glass transition temperature of the resin constituting the release layer 5 of 110° C. or lower allows the fluorocarbon-based surfactant in the primer layer 3 to diffuse into the release layer 5 and to reach the interface between the release layer 5 and the protective layer 6 when the protective layer 6 is thermally transferred. This preferably results in satisfactory releasability and improvement in the glossiness of the transferred protective layer 6.

The protective layer 6 stacked on the release layer 5 is formed of a thermally transferable transparent resin layer. The protective layer 6 is transferred by heat from a heater such as a thermal head onto a color image formed by transferring dyes and the like onto a thermal transfer image receiving sheet in order to protect the image.

Examples of a resin constituting the protective layer 6 include polyester resins, polystyrene resins, acrylic resins, polyurethane resins, acrylic urethane resins, polycarbonate resins, epoxy-modified resins thereof, silicone-modified resins thereof, mixtures thereof, ionizing radiation-curable resins, and ultraviolet-screening resins. Polyester resins, polystyrene, acrylic resins, polycarbonate resins, and epoxy-modified resins are preferred. Among these, at least one copolymer selected from styrene, methyl methacrylate, ethyl methacrylate, vinyl chloride-vinyl acetate, vinyl chloride, and cellulose ester derivative copolymers is preferred because the at least one copolymer exhibits satisfactory adhesion when thermal transfer is not performed, exhibits satisfactory releasability when thermal transfer is performed, and has satisfactory glossiness. Polystyrene resins, modified polystyrene resins, and copolymers thereof are most preferred.

The protective layer 6 may have an adhesive sublayer arranged on a side of the protective layer 6 opposite the side adjacent to the release layer 5, i.e. a two-layer structure. The adhesive sublayer is located between the protective layer 6 and a thermal transfer image receiving sheet when the protective layer 6 is thermally transferred to the thermal transfer image receiving sheet to bond the protective layer 6 to a color image and improve the adhesion of the protective layer 6.

Any resin containing, for example, an adhesive or a heat-sensitive adhesive in the related art may be used as the resin constituting the adhesive sublayer. A thermoplastic resin having a glass transition temperature (Tg) of 30° C. to 80° C. is preferred. Specific examples of the thermoplastic resins include polyester resins, vinyl chloride-vinyl acetate copolymer resins, acrylic resins, butyral resins, epoxy resins, polyamide resins, and vinyl chloride resins. The adhesive sublayer may contain additives, such as an ultraviolet absorber, an antioxidant, and a fluorescent brightening agent.

Each of the primer layer 3, the ink layers 4Y, 4M, and 4C, the release layer 5, and the protective layer 6 described above may appropriately contain various additives, such as wax and an ultraviolet absorber described below.

Examples of the wax include polyethylene wax, polyester wax, polystyrene powders, olefin powders, microcrystalline wax, carnauba wax, paraffin wax, Fischer-Tropsch wax, various low-molecular-weight polyethylenes, Japan tallow, beeswax, spermaceti, lanoline, shellac wax, candelilla wax, petrolatum, partially-modified wax, fatty acid esters, and fatty acid amides.

Examples of the ultraviolet absorber include salicylic acid-, benzophenone-, benzotriazole-, and cyanoacrylate-based ultraviolet absorbers. Specific examples thereof include Tinuvin P, Tinuvin 234, Tinuvin 320, Tinuvin 326, Tinuvin 327, Tinuvin 328, Tinuvin 312, and Tinuvin 315 (produced by Nihon Ciba-Geigy K.K.); Sumisorb-110, Sumisorb-130, Sumisorb-140, Sumisorb-200, Sumisorb-250, Sumisorb-300, Sumisorb-320, Sumisorb-340, Sumisorb-350, and Sumisorb-400 (produced by Sumitomo Chemical Co., Ltd.); and Mark LA-32, Mark LA-36, and Mark 1413 (produced by Adeka Corporation), which are commercially available. These may be used for the thermal transfer recording medium 1.

Furthermore, a random copolymer of a reactive ultraviolet absorber and an acrylic monomer may be used, the random copolymer having a glass transition temperature (Tg) of 60° C. or higher and preferably 80° C. or higher.

Examples of the reactive ultraviolet absorber that can be used include reactive ultraviolet absorbers each prepared by introducing an addition polymerizable double bond, e.g., a vinyl, acryloyl, or methacryloyl group, or an alcoholic hydroxy, amino, carboxy, epoxy, or isocyanato group into a nonreactive ultraviolet absorber, e.g., a salicylate-, benzophenone-, benzotriazole-, substituted acrylonitrile-, nickel chelate-, or hindered amine-based ultraviolet absorber, used in the related art. Specific examples thereof include UVA635L and UVA633L (produced by BASF Japan Ltd.); and PUVA-30M (produced by Otsuka Chemical Co., Ltd.), which are commercially available. These may be used for the thermal transfer recording medium 1.

The random copolymer of the reactive ultraviolet absorber and the acrylic monomer has a reactive ultraviolet absorber content of 10% to 90% by mass and preferably 30% to 70% by mass. The random copolymer has a molecular weight of about 5,000 to about 250,000 and preferably about 9,000 to about 30,000. The foregoing ultraviolet absorbers and random copolymer of the reactive ultraviolet absorber and the acrylic monomer may be used alone. Alternatively, the ultraviolet absorbers and the random copolymer may both be contained. The proportion of the random copolymer of the reactive ultraviolet absorber and the acrylic monomer in a layer to which the random copolymer is added is preferably in the range of 5% to 50% by mass.

Furthermore, a light-resistance-imparting agent may be used in addition to the ultraviolet absorber. The term “light-resistance-imparting agent” indicates an agent configured to absorb or block the deterioration or decomposition of dye due to light energy, thermal energy, and oxidation and to prevent the deterioration and decomposition of dye. Examples of the light-resistance-imparting agent include antioxidants and light stabilizers serving as additives used for synthetic resins in the related art in addition to the foregoing ultraviolet absorbers. Also in this case, the light-resistance-imparting agent may be contained in at least one of the release layer 5, the protective layer 6, and the adhesive sublayer. Particularly preferably, the light-resistance-imparting agent may be contained in the heat-sensitive adhesive sublayer.

Examples of antioxidants include primary antioxidants, such as phenol-, monophenol-, bisphenol-, and amine-based antioxidants; and secondary antioxidants, such as sulfur- and phosphorus-based antioxidants. Examples of light stabilizers include hindered amine-based light stabilizers.

The proportion of the light-resistance-imparting agent including the ultraviolet absorber is not particularly limited but is preferably in the range of 0.05 to 10 parts by weight and more preferably 3 to 10 parts by weight with respect to 100 parts by weight of a resin constituting a layer to which the agent is added. A proportion of the light-resistance-imparting agent of 0.05 to 10 parts by weight with respect to 100 parts by weight of the resin provides the effect of the light-resistance-imparting agent and is economical.

In addition to the light-resistance-imparting agent, appropriate amounts of various additives, such as a fluorescent brightening agent and a filler, may also be added to the adhesive sublayer.

As described above, the yellow ink layer 4Y, the magenta ink layer 4M, the cyan ink layer 4C, and the protective layer 6 are aligned on the one surface 2a of the base 2. Alternatively, the protective layer 6 may be arranged alone without the ink layers 4Y, 4M, and 4C.

The heat-resistant slipping layer is preferably arranged on the other surface 2b, which is a surface of the base 2 opposite the surface adjacent to the ink layers 4Y, 4M, and 4C and the protective layer 6.

The heat-resistant slipping layer is arranged so as to prevent the fusion of a heater such as a thermal head and the base 2, smoothen the travel of the thermal transfer recording medium 1, and remove adherents on the thermal head.

Examples of a resin used for the heat-resistant slipping layer include naturally occurring and synthetic resins, such as cellulosic resins, e.g., ethyl cellulose, hydroxy cellulose, hydroxypropyl cellulose, methyl cellulose, cellulose acetate, cellulose acetate butyrate, and nitro cellulose, vinyl resins, e.g., polyvinyl alcohol, polyvinyl acetate, polyvinyl butyral, polyvinyl acetal, and polyvinylpyrrolidone, acrylic resins, e.g., polymethyl methacrylate, polyethyl acrylate, polyacrylamide, and acrylonitrile-styrene copolymers, polyimide resins, polyamide resins, polyamide-imide resins, polyvinyl toluene resins, coumarone-indene resins, polyester resins, polyurethane resins, and silicone- or fluorine-modified urethane. These may be used separately or in combination as a mixture. To enhance heat resistance, the heat-resistant slipping layer is preferably composed of a crosslinked resin prepared from a resin containing a reactive group such as a hydroxy group among the foregoing resins and polyisocyanate serving as a crosslinking agent.

The heat-resistant slipping layer may further contain a solid or liquid release agent or lubricant in order to have improved sliding properties on the thermal head. In this case, the heat-resistant slipping layer has heat-resistant slidability. Examples of the release agent or lubricant that can be used include various waxes, such as polyethylene wax and paraffin wax, higher aliphatic alcohols, organopolysiloxane, anionic surfactants, cationic surfactants, amphoteric surfactants, nonionic surfactants, fluorocarbon-based surfactants, metallic soap, organic carboxylic acids and derivatives thereof, fluorocarbon-based resins, silicone resins, and microparticles of inorganic compounds such as talc and silica. The heat-resistant slipping layer has a lubricant content of about 5% to about 50% by mass and preferably about 10% to about 30% by mass. The heat-resistant slipping layer has a thickness of about 0.1 to about 10 μm and preferably about 0.3 to about 5 μm.

In the thermal transfer recording medium 1, even if the lubricant in the heat-resistant slipping layer is melted by heat from the thermal head, the specific fluorocarbon-based surfactant contained in the primer layer 3 is diffused to the interface between the release layer 5 and the protective layer 6 to facilitate the detachment of the protective layer 6 from the release layer 5, thereby transferring the protective layer 6 onto a color image without causing uneven glossiness.

A thermal transfer image receiving sheet, not shown, onto which the yellow, magenta, and cyan dyes and the protective layer 6 are transferred from the thermal transfer recording medium 1 having the structure described above includes a receiving layer arranged on a support, the receiving layer being configured to receive coloring matter.

The support serves to support the receiving layer. The support preferably has mechanical strength enough to achieve good handling under heat because the sheet is heated when thermal transfer is performed.

A material constituting the support is not particularly limited. Examples thereof include capacitor paper, glassine paper, parchment paper, paper having a high sizing content, synthetic paper (polyolefin- and polystyrene-based paper), wood-free paper, art paper, coated paper, cast coated paper, wallpaper, lined paper, synthetic resin- or emulsion-impregnated paper, synthetic rubber latex-impregnated paper, synthetic resin-containing paper, paperboards, cellulose fiber paper, and films composed of polyester, polyacrylate, polycarbonate, polyurethane, polyimide, polyetherimide, cellulose derivatives, polyethylene, ethylene-vinyl acetate copolymers, polypropylene, polystyrene, acrylic, polyvinyl chloride, polyvinylidene chloride, polyvinyl alcohol, polyvinyl butyral, nylon, polyether ether ketone, polysulfone, polyether sulfone, tetrafluoroethylene, perfluoroalkyl vinyl ether, polyvinyl fluoride, tetrafluoroethylene-ethylene, tetrafluoroethylene-hexafluoropropylene, polychlorotrifluoroethylene, and polyvinylidene fluoride. White opaque films containing the synthetic resins, white pigments, and fillers and foamed sheets may also be used as the support. The support is not particularly limited.

A laminate of any combination thereof may also be used. Typical examples of the laminate include a laminate of cellulose fiber paper and synthetic paper and a laminate of cellulose synthetic paper and a plastic film. The support may have any thickness and usually has about 10 to about 300 μm.

To enhance the printing sensitivity and obtain a high quality image without print dropouts or nonuniformity in density, the support preferably includes a layer having microvoids. The layer may be formed of a plastic film or synthetic paper having microvoids therein. Alternatively, a layer having microvoids may be formed on the support by any coating method.

A mixture of a polyolefin resin such as polypropylene or a polyester resin such as polyethylene terephthalate, which is a main component, and an inorganic pigment and/or a polymer incompatible with polypropylene, which serves as a void-forming initiator, is stretched and formed into a plastic film or synthetic paper, which is preferred as the plastic film or synthetic paper having microvoids.

In view of these points, each of the plastic film and the synthetic paper preferably has an elastic modulus of 5×10⁸ Pa to 1×10¹⁰ Pa at 20° C. The plastic film and the synthetic paper are usually formed by biaxial stretching and thus shrink by heating. The plastic film and the synthetic paper each exhibit a shrinkage of 0.5% to 2.5% when they are allowed to stand at 110° C. for 60 seconds. Each of the plastic film and the synthetic paper may have a single layer structure or multilayer structure with microvoids. In the case of the multilayer structure, all layers in the multilayer structure may have microvoids. Alternatively, the multilayer structure may have a microvoid-free layer. Each of the plastic film and the synthetic paper may contain a white pigment serving as a masking agent, as needed. To improve the degree of whiteness, an additive such as a fluorescent brightening agent may be incorporated. The layer having microvoids preferably has a thickness of 30 to 80 μm.

A plastic resin may be applied onto the support by coating to form a layer having microvoids. Examples of the plastic resin that can be used include resins used in the related art, for example, polyester, urethane resins, polycarbonate, acrylic resins, polyvinyl chloride, and polyvinyl acetate. These resins may be used alone or in combination as a mixture.

To prevent curling, if necessary, the support may include a layer of synthetic paper or a layer composed of a resin such as polyvinyl alcohol, polyvinylidene chloride, polyethylene, polypropylene, modified polyolefin, polyethylene terephthalate, or polycarbonate, the layer being arranged on a side of the support opposite the side adjacent to an image-receiving layer. To laminate the support and the resin or synthetic-paper layer, a lamination method used in the related art, for example, dry lamination, non-solvent lamination (hot-melt lamination), or EC lamination, can be employed. Dry lamination and non-solvent lamination are preferred. An example of an adhesive suitably used in non-solvent lamination is Takenate 720L (produced by Takeda Pharmaceutical Company Limited). Examples of an adhesive suitably used in dry lamination include Takelack A969/Takenate A-5 (3/1) (produced by Takeda Pharmaceutical Company Limited); and Polysol PSA SE-1400 and Vinylol PSA AV-6200 series (produced by Showa Highpolymer Co., Ltd). Each of the adhesives is used in an amount of about 1 to about 8 g/m² and preferably about 2 to about 6 g/m² as a solid component.

In the case of forming a laminate of the plastic film and synthetic paper, a laminate of the plastic films, a laminate of synthetic paper sheets, and a laminate of various types of paper and the plastic film, synthetic paper, or the like, they may be bonded with an adhesive layer.

To increase the adhesive strength between the support and a dye-receiving layer, the support may be subjected to surface treatment such as primer treatment or corona discharge treatment.

A coloring-matter-receiving layer configured to receive coloring matter such as dye and formed on the support is mainly composed of a binder resin. Binder resins used in the related art may be used. Among these, the binder resin that dyes well is preferably used. Specific examples thereof include polyolefin resins such as polypropylene; halogenated resins, such as polyvinyl chloride and polyvinylidene chloride; vinyl resins, such as polyvinyl acetate, polyacrylate, polyvinyl butyral, and polyvinyl acetal; polyester resins, such as polyethylene terephthalate and polybutylene terephthalate; polystyrene resins, such as polystyrene and polystyrene acrylonitrile; polyamide resins; phenoxy resins; copolymers of olefins, such as ethylene and propylene, and vinyl monomers; polyurethane; polycarbonate; acrylic resins; ionomers; and cellulose derivatives. These may be used separately or in combination as a mixture. Among these, acrylic resins, polyester resins, vinyl resins, polystyrene resins, and cellulose derivatives are preferred.

The coloring-matter-receiving layer preferably contain a release agent in order to prevent thermal fusion between the coloring-matter-receiving layer and the ink layers 4Y, 4M, and 4C of the thermal transfer recording medium 1. Examples of the release agent that can be used include phosphate-based plasticizer, fluorocarbon-based compounds, and silicone oil (including reaction curable silicone). Among these, silicone oil is preferred. As the silicon oil, various modified silicones such as dimethylsilicone can be used. Examples thereof include amino-modified silicones, epoxy modified-silicones, alcohol-modified silicones, vinyl-modified silicones, and urethane-modified-silicones. Mixtures thereof or polymers prepared by polymerization of these using various reactions may be used. These release agents may be used alone or in combination or two or more. The release agent content is preferably in the range of 0.5 to 30 parts by weight with respect to 100 parts by weight of the binder resin constituting the coloring-matter-receiving layer. A release agent content of 0.5 to 30 parts by weight results in the prevention of fusion between the thermal transfer recording medium 1 and the coloring-matter-receiving layer of the thermal transfer image receiving sheet and a reduction in printing sensitivity. The release agent may not be added to the coloring-matter-receiving layer. Alternatively, a release layer containing the release agent may be formed on the coloring-matter-receiving layer.

The thermal transfer image receiving sheet may further include an intermediate layer arranged between the support and the coloring-matter-receiving layer. The term “intermediate layer” indicates all layers arranged between the support and the coloring-matter-receiving layer. The intermediate layer may have a multilayer structure. The intermediate layer has, for example, solvent resistance, barrier properties, adhesion properties, whitening properties, masking properties, antistatic properties, without limitation. Any intermediate layer used in the related art may be applied.

To impart solvent resistance and barrier properties to the intermediate layer, a water-soluble resin is preferably used. Examples of the water-soluble resin include cellulosic resins such as carboxymethyl cellulose; polysaccharide resins such as starch; protein such as casein; gelatin; agar; vinyl resins, such as polyvinyl alcohol, ethylene-vinyl acetate copolymers, polyvinyl acetate, vinyl chloride, vinyl acetate copolymers (e.g., VeoVa, produced by Japan Epoxy Resins Co., Ltd.), vinyl acetate-(meth)acrylic copolymers, (meth)acrylic resins, styrene-(meth)acrylic copolymers, and styrene resins; polyamide resins, such as melamine resins, urea resins, and benzoguanaminae resins; polyester; and polyurethane. The term “water-soluble resin” used here indicates a resin which is completely soluble (particle size: 0.01 μm or less) in a solvent mainly composed of water or which can be mixed with a solvent mainly composed of water to form a colloidal dispersion (0.01 to 0.1 μm), an emulsion (0.1 to 1 μm), or a slurry (1 μm or more). Among these water-soluble resins, resins that are insoluble and do not swell in alcohols, such as methanol, ethanol, and isopropyl alcohol, or general-purpose solvents, such as hexane, cyclohexane, acetone, methyl ethyl ketone, xylene, ethyl acetate, butyl acetate, and toluene, are particularly preferred. In this sense, resins that are completely soluble in a solvent mainly composed of water are most preferred. Specific examples thereof include polyvinyl alcohol resins, ethylene-vinyl alcohol copolymers, polyvinylpyrrolidone, polyethylene oxide, and cellulosic resins.

Although the material constituting the intermediate layer varies depending on the type of support and surface treatment to which the support is subjected, a urethane resin or a polyolefin resin is typically used in order to impart adhesion properties to the intermediate layer. Furthermore, the use of a combination of an active-hydrogen-containing thermoplastic resin and a curing agent such as an isocyanate compound results in satisfactory adhesion of the intermediate layer.

To impart whitening properties to the intermediate layer, a fluorescent brightening agent is preferably added thereto. Any fluorescent brightening agent used in the related art may be used. Examples thereof include composed of stilbene-, distilbene-, benzoxazole-, styryl-oxazole-, pyrene-oxazole-, coumarin-, aminocoumarin-, imidazole-, benzimidazole-, pyrazoline-, and distyryl-biphenyl-based fluorescent brightening agents. The degree of whiteness can be adjusted by the type and amount of the fluorescent brightening agent. The fluorescent brightening agent may be added by any method. Examples thereof include a method in which the fluorescent brightening agent is dissolved in water and then the resulting solution is added; a method in which the fluorescent brightening agent is pulverized and dispersed with a ball mill or a colloid mill and then the resulting dispersion is added; a method in which the fluorescent brightening agent is dissolved in a high-boiling-point solvent, the resulting solution is mixed with a hydrophilic colloidal solution to form an oil-in-water dispersion, and the resulting dispersion is added; and a method in which the fluorescent brightening agent is impregnated in a polymer latex, and the fluorescent brightening agent-containing latex is added.

To reduce the glare and nonuniformity of the support, titanium oxide may be added to the intermediate layer. Furthermore, the addition of the titanium oxide to the intermediate layer increases the flexibility in the choice of a material constituting the support and is thus preferred. Titanium oxide includes two types: rutile titanium oxide and anatase titanium oxide. In view of the degree of whiteness and the effect of the fluorescent brightening agent, anatase titanium oxide is preferred because anatase titanium oxide absorbs an ultraviolet ray having a wavelength shorter than that absorbed by rutile titanium oxide. In the case where the intermediate layer is composed of a hydrophilic resin and thus titanium oxide particles are not easily dispersed therein, titanium oxide particles subjected to hydrophilic surface treatment is used to disperse the titanium oxide particles. Alternatively, a dispersant, such as a surfactant or ethylene glycol, used in the related art is used to disperse the titanium oxide particles. The amount of titanium oxide added is preferably in the range of 10 to 400 parts by weight as titanium oxide solids with respect to 100 parts by weight of the resin solids.

To impart antistatic properties to the intermediate layer, preferably, a conductive material, such as a conductive inorganic filler or an organic conductive material, e.g., polyaniline sulfonic acid, used in the related art is selected in response to the resin and added thereto. The intermediate layer preferably has a thickness of about 0.1 to about 10 μm.

The yellow ink layer 4Y, the magenta ink layer 4M, and the cyan ink layer 4C of the thermal transfer recording medium 1 are successively heated with a heater such as a thermal head to transfer yellow, magenta, and cyan dyes onto the coloring-matter-receiving layer of the thermal transfer image receiving sheet as described above, so that the dyes are held in the coloring-matter-receiving layer to form a color image. Then the protective layer 6 is heated to detach the protective layer 6 at the interface between the protective layer 6 and the release layer 5 and transferred onto the color image, thereby affording the color image protected by the protective layer 6.

The thermal transfer recording medium 1 includes the primer layer 3 on the base 2. The protective layer 6 is arranged on the primer layer 3 with the release layer 5 provided therebetween. The primer layer 3 contains a specific fluorocarbon-based surfactant. The release layer 5 has a glass transition temperature of 60° C. to 110° C. The fluorocarbon-based surfactant in the primer layer 3 bonds the base 2 and the release layer 5 before the protective layer 6 is transferred onto a color image, thus preventing detachment of the protective layer 6. To transfer the protective layer 6, the thermal transfer recording medium 1 is heated with the thermal head to diffuse the fluorocarbon-based surfactant to the interface between the release layer 5 and the protective layer 6, thereby facilitating detachment of the protective layer 6 from the release layer 5 at the interface therebetween and resulting in successful transfer of the protective layer 6. The transferred protective layer 6 has a high degree of glossiness and uniform gloss, so that a satisfactory image having uniform image and gloss can be formed, and satisfactory recording characteristics can be achieved.

### EXAMPLES

A thermal transfer recording medium according to an embodiment of the present invention will be described by means of examples and comparative examples.

### Example 1

In Example 1, a film subjected to treatment for improving bondability (trade name: 602 6.0E, manufactured by Diafoil Corp.) having a thickness of 6 μm was used as a base film. A back layer coating solution (heat-resistant layer coating solution) having a composition shown in Table 1 was applied to one surface of the base film by printing, followed by drying to form a back layer. A primer layer coating solution having a composition shown in Table 2 was applied to the other surface by printing, followed by drying to form a primer layer. The primer layer contained a fluorocarbon-based surfactant (carboxylic acid salt) of the formula (1).

TABLE 1

| Back layer coating solution | Content |
|---|---|
| Polyvinyl butyral resin | 3.5 parts by weight |
| (S-Lec BX-1, from Sekisui Chemical | |
| Co., Ltd.) | |
| Phosphate-based surfactant | 3.0 parts by weight |
| (Plysurf A208S, from Dai-ichi Kogyo | |
| Seiyaku Co., Ltd.) | |
| Phosphate-based surfactant | 0.3 parts by weight |
| (Phosphanol RD-720, from Toho | |
| Chemical Industry Co., Ltd.) | |
| Polyisocyanate | 19.0 parts by weight |
| (Burnock D750-45, from DIC | |
| Corporation) | |
| Talc | 0.2 parts by weight |
| (Y/X = 0.03, from Nippon Talc Co., | |
| Ltd.) | |
| Methyl ethyl ketone | 35.0 parts by weight |
| Toluene | 35.0 parts by weight |

TABLE 2

| Primer layer coating solution | Content |
|---|---|
| Self-crosslinkable acrylic emulsion | 40 parts by weight |
| (Mowinyl LDM7582, from The Nippon | |
| Synthetic Chemical Industry Co., | |
| Ltd.) | |
| Fluorocarbon-based surfactant | 0.05 parts by weight |
| (Ftergent 100C, from Neos Co., Ltd.) | |
| Deionized water | 20 parts by weight |

A yellow ink for an ink layer shown in Table 3, a magenta ink for an ink layer, and a cyan ink for an ink layer were applied onto the base film with a multicolor gravure coater to form ink layers. A release layer, a protective layer, and an adhesive layer were stacked, in that order, on the base film next to the cyan ink layer. The yellow ink layer, the magenta ink layer, the cyan ink layer, and the protective layer were aligned on the base film to form a thermal transfer recording medium. The magenta ink for the ink layer was prepared as in the yellow ink for the ink layer, except that 2 parts by weight of a magenta dye (trade name: MS Red G, produced by Mitsui Chemicals, Inc.) was used in place of the yellow dye. The cyan ink for the ink layer was prepared as in the yellow ink for the ink layer, except that 4 parts by weight of a cyan dye (trade name: DH-C2, produced by Nippon Kayaku Co., Ltd.) was used in place of the yellow dye. Table 4 shows a release layer coating solution configured to form a release layer. Table 5 shows a protective layer coating solution configured to form a protective layer. Table 6 shows an adhesive layer coating solution configured to form an adhesive layer.

TABLE 3

| Yellow ink for ink layer | Content |
|---|---|
| Yellow dye | 3 parts by weight |
| (trade name: Foron Brilliant Yellow | |
| S-6GL, from Sandoz K.K.) | |
| Acetoacetal | 4 parts by weight |
| (trade name: S-Lec KS-5, from | |
| Sekisui Chemical Co., Ltd.) | |
| Silicone microparticles | 0.5 parts by weight |
| (Tosperl 120, from GE Toshiba | |
| Silicones Co., Ltd.) | |
| Methyl ethyl ketone | 50 parts by weight |
| Toluene | 43 parts by weight |

TABLE 4

| Release layer coating solution | Content |
|---|---|
| Polyvinyl acetoacetal | 7 parts by weight |
| (S-Lec KS-10, Tg: 106° C., from | |
| Sekisui Chemical Co., Ltd.) | |
| Methyl ethyl ketone | 53 parts by weight |
| Toluene | 40 parts by weight |

TABLE 5

| Protective layer coating solution | Content |
|---|---|
| AS resin | 20 parts by weight |
| (Stylac As, from Asahi Kasei | |
| Chemicals Corp.) | |
| Ultraviolet absorbing resin | 2.0 parts by weight |
| (UVA635L, from BASF Japan Ltd.) | |
| Methyl ethyl ketone | 40 parts by weight |
| Toluene | 38 parts by weight |

TABLE 6

| Adhesive layer coating solution | content |
|---|---|
| Acrylic resin | 6 parts by weight |
| (Dianal BR90, from Mitsubishi Rayon | |
| Co., Ltd.) | |
| Hydrogenated petroleum resin | 1.0 parts by weight |
| (Arkon P100, from Arakawa Chemical | |
| Industries, Ltd.) | |

### Example 2

In Example 2, a thermal transfer recording medium was prepared as in Example 1, except that the fluorocarbon-based surfactant used for the primer layer was replaced with a fluorocarbon-based surfactant (trade name: Ftergent 150, produced by Neos Co., Ltd.) having a sulfobetaine structure shown in the formula (1) and the polyvinyl acetoacetal used for the release layer was replaced with a polyvinyl acetoacetal (trade name: S-Lec BX-1, Tg: 90° C., produced by Sekisui Chemical Co., Ltd).

### Example 3

In Example 3, a thermal transfer recording medium was prepared as in Example 1, except that the fluorocarbon-based surfactant used for the primer layer was replaced with a fluorocarbon-based surfactant (trade name: FC4430, produced by Sumitomo 3M Limited) represented by the formula (1) and the polyvinyl acetoacetal used for the release layer was replaced with a polyvinyl acetoacetal (trade name: S-Lec BX-5, Tg: 86° C., produced by Sekisui Chemical Co., Ltd).

### Example 4

In Example 4, a thermal transfer recording medium was prepared as in Example 1, except that the fluorocarbon-based surfactant used for the primer layer was replaced with a fluorocarbon-based surfactant (trade name: Fluorad FC-93, produced by Sumitomo 3M Limited) represented by the formula (2) and the polyvinyl acetoacetal used for the release layer was replaced with a polyvinyl acetoacetal (trade name: S-Lec BL-5, Tg: 62° C., from Sekisui Chemical Co., Ltd).

### Comparative Example 1

In Comparative Example 1, a thermal transfer recording medium was prepared as in Example 1, except that the fluorocarbon-based surfactant used for the primer layer was replaced with a fluorocarbon-based surfactant (trade name: Fluorad FC-93, produced by Sumitomo 3M Limited) and the polyvinyl acetoacetal used for the release layer was replaced with a polyvinyl acetoacetal (trade name: S-Lec BL-10, Tg: 59° C., from Sekisui Chemical Co., Ltd).

### Comparative Example 2

In Comparative Example 2, a thermal transfer recording medium was prepared as in Example 1, except that the fluorocarbon-based surfactant used for the primer layer was replaced with a fluorocarbon-based surfactant (trade name: Ftergent 100C, from Neos Co., Ltd.) and the polyvinyl acetoacetal used for the release layer was replaced with polyvinylpyrrolidone (trade name: K-30, Tg: 126° C., produced by ISP (Japan) Ltd).

### Comparative Example 3

In Comparative Example 3, a thermal transfer recording medium was prepared as in Example 1, except that the release layer was not formed.

### Comparative Example 4

In Comparative Example 4, a thermal transfer recording medium was prepared as in Example 1, except that the fluorocarbon-based surfactant used for the primer layer was replaced with a Si-based surfactant (trade name: KS-531, produced by Shin-Etsu Chemical Co., Ltd.) and the polyvinyl acetoacetal used for the release layer was replaced with a polyvinyl acetoacetal (trade name: S-Lec BX-1, Tg: 90° C., produced by Sekisui Chemical Co., Ltd).

A thermal transfer image receiving sheet was produced as follows. Synthetic paper sheets (Yupo FPG #200, produced by Yupo Corporation) each having a thickness of 20 μm and subjected to corona discharge treatment were bonded to both surfaces of coated printing paper (SA Kinfuji, basis weight: 127.9 g/m², produced by Oji Paper Co., Ltd.) by dry lamination. An underlying-layer-forming coating solution having a composition shown in Table 7 was applied to a surface, which had been subjected to corona discharge treatment, by wire-bar coating, followed by drying to form an underlying layer having a thickness of 0.5 μm.

TABLE 7

| Underlying layer coating solution | Content |
|---|---|
| Polyvinyl butyral | 8 parts by weight |
| (S-Lec BM-1, from Sekisui Chemical Co., | |
| Ltd.) | |
| Epoxy-modified silicone (dual-end type) | 1.2 parts by weight |
| (X-22-163B, from Shin-Etsu Chemical | |
| Co., Ltd.) | |
| Isocyanate | 0.8 parts by weight |
| (Coronate HX-Coronate 3041 (1:1) | |
| mixture, from Nippon Polyurethane | |
| Industry Co., Ltd.) | |
| Methyl ethyl ketone | 80 parts by weight |
| Butyl acetate | 10 parts by weight |

A image-receiving-layer-forming coating solution having a composition shown in Table 8 was prepared and applied onto the underlying layer by wire-bar coating, followed by drying to form an image-receiving layer (receiving layer) having a thickness of 4 μm, thereby forming a thermal transfer image receiving sheet.

TABLE 8

| Image-receiving-layer coating solution | Content |
|---|---|
| Polyvinyl butyral resin | 8 parts by weight |
| (S-Lec BX-1, butyral content: 70 mol %, | |
| unsaponified vinyl acetate moiety: 3 mol | |
| %, from Sekisui Chemical Co., Ltd.) | |
| Succinic acid polyester polyol | 2 parts by weight |
| (Maximol FSK-1200, from Kawasaki Kasei | |
| Chemicals Ltd.) | |
| Epoxy-modified silicone (dual-end type) | 1.2 parts by weight |
| (X-22-163B, from Shin-Etsu Chemical | |
| Co., Ltd.) | |
| Isocyanate | 0.8 parts by weight |
| (Coronate HX-Coronate HK (1:1) mixture, | |
| from Nippon Polyurethane Industry Co., | |
| Ltd.) | |

Evaluations of nonuniformity in image density (corduroy-like pattern, uneven glossiness) of the transferred protective layers and the detachment of the protective layers were conducted using the thermal transfer recording media and the thermal transfer image receiving sheets produced in Examples 1 to 4 and Comparative Examples 1 to 4. Table 9 shows the evaluation results.

TABLE 9

| | | Nonuniformity | |
|---|---|---|---|
| | | in glossiness | |
| | Glossiness | (corduroy) | Detachment |
| Example 1 | 88.4 | Good | Excellent |
| Example 2 | 82.2 | Excellent | Excellent |
| Example 3 | 78.2 | Excellent | Good |
| Example 4 | 75.4 | Good | Good |
| Comparative | 70.3 | Poor | Excellent |
| Example 1 | | | |
| Comparative | 81.3 | Poor | Good |
| Example 2 | | | |
| Comparative | 23.4 | Fair | Good |
| Example 3 | | | |
| Comparative | 74.4 | Terrible | Good |
| Example 4 | | | |

An evaluation method is described below: Solid black printing was performed at the maximum density with a dye sublimation printer DR-150 (manufactured by Sony Corporation) using the thermal transfer recording media and the thermal transfer image receiving sheets produced in Examples 1 to 4 and Comparative Examples 1 to 4. Glossiness (measurement angle: 20°) was measured in a subscanning direction of a thermal head, i.e., in the transport direction of the thermal transfer image receiving sheets.

The nonuniformity in image density was attributed to a stripe pattern (corduroy-like pattern) parallel to the subscanning direction of the thermal head and was evaluated according to the following criteria. “Poor” and “Terrible” were not allowable levels as commercial products.
Excellent: Uniform glossiness is observed at an image portion.
Good: A negligible nonuniformity in glossiness is observed at ends of an image portion but is allowable.
Fair: Only a slight nonuniformity in glossiness is observed at an image portion but is allowable.
Poor: A stripe pattern due to nonuniformity in glossiness is clearly visually observed at an image portion, and the nonuniformity is not allowable.
Terrible: A stripe pattern is observed on the entire surface, and the nonuniformity is completely unallowable.

The evaluation of the detachment was performed as follows: The thermal transfer recording media each having a size of 10 cm×10 cm and produced in Examples 1 to 4 and Comparative Examples 1 to 4 were crumpled at 23° C. and 55 RH %. Then the crumpled media were completely unfolded. Visual inspection was performed according to the following criteria. “Poor” and “Terrible” are not allowable levels as commercial products.
Excellent: No detachment of a transferable protective layer is observed.
Good: Dot-pattern detachment is slightly observed but is allowable.
Fair: Dot-pattern detachment is observed but is allowable.
Poor: Severe dot-pattern detachment is observed and is not allowable.
Terrible: A large number of completely detached portions are observed, and this state is not allowable.

The results shown in Table 9 demonstrated the following: in each of Examples 1 to 4, at least one fluorocarbon-based surfactant selected from compounds of the formulae (1) to (3) was contained in the primer layer, and the release layer had a glass transition temperature of 60° C. to 110° C. Thus, the fluorocarbon-based surfactant was present in the primer layer, thereby improving the adhesion between the base and the release layer. As a result, the protective layer was not detached from the base, i.e., the detachment was prevented. When the protective layer was transferred, the fluorocarbon-based surfactant was diffused by heating with a thermal head to the interface between the release layer and the protective layer, thereby resulting in satisfactory releasability of the protective layer. Thus, the occurrence of the corduroy-like pattern was prevented.

In contrast, in Comparative Example 1, the material constituting the release layer had a glass transition temperature of 59° C., which was lower than 60° C. Thus, when the protective layer was transferred, the fluorocarbon-based surfactant in the primer layer was not easily diffused into the release layer, so that the protective layer was not easily detached, causing the corduroy-like pattern.

In Comparative Example 2, the material constituting the release layer had a glass transition temperature of 126° C., which was higher than 110° C. Thus, the fluorocarbon-based surfactant was not easily diffused into the release layer, so that the protective layer was not easily detached, causing the corduroy-like pattern.

In Comparative Example 3, since the release layer was not formed between the primer layer and the protective layer, the protective layer was not easily detached, causing the corduroy-like pattern.

In Comparative Example 4, the primer layer did not contain at least one fluorocarbon-based surfactant selected from compounds of the formulae (1) to (3) but contained the silicon-based surfactant. The silicon-based surfactant was not diffused into the release layer, so that the protective layer was not easily detached, causing the corduroy-like pattern over the entire surface.

From the results of Examples and Comparative Examples, in the case where at least one fluorocarbon-based surfactant selected from compounds of the formulae (1) to (3) is present between the base and the release layer and where the release layer has a glass transition temperature of 60° C. to 110° C., the detachment of the protective layer from the release layer can be prevented when the protective layer is not transferred. The protective layer is easily detached from the release layer when the protective layer is transferred, thus preventing the occurrence of the corduroy pattern. As a result, a satisfactory image having uniform image and gloss can be formed, and satisfactory recording characteristics can be achieved.

It should be understood by those skilled in the art that various modifications, combinations, sub-combinations and alterations may occur depending on design requirements and other factors insofar as they are within the scope of the appended claims or the equivalents thereof.

What is claimed is:

1. A thermal transfer recording medium including at least one transferable protective layer arranged on a base with a non-transferable release layer provided therebetween, in which the protective layer is detached from the release layer at the interface between the at least one protective layer and the release layer during thermal transfer printing and then thermally transferred onto an image, comprising:
a primer layer containing at least one fluorocarbon-based surfactant, the primer layer, the release layer, and the protective layer being stacked, in that order, on one surface of the base,
wherein the release layer has a glass transition temperature of 60° C. to 110° C.

2. The thermal transfer recording medium according to claim 1, wherein the fluorocarbon-based surfactant contains at least one selected from compounds of the formulae (1) to (3):
Rf-(L₁)ₘ-(Y₁)ₙ—X formula (1)
(wherein Rf represents an aliphatic group containing at least one fluorine atom; L₁ represents a divalent linking group; Y₁ represents an optionally substituted alkyleneoxy group, alkylene group, or alkenyl group; X represents a hydrogen atom, a hydroxy group, an anionic group, or a cationic group; m represents zero or an integer of 1 to 5; and n represents zero or an integer of 1 to 40);
Rf—(O−Rf′)ₙ₁-L₂-X′ₘ₁ formula (2)
(wherein Rf represents an aliphatic group containing at least one fluorine atom; Rf′ represents an alkylene group containing at least one fluorine atom; L₂ represents a simple bond or a linking group; X′ represents a hydroxy group, an anionic group, or a cationic group; and n1 and m1 each represent an integer of 1 or more); and
[(Rf″O)ₙ₂—(PFC)—CO—Y₂]ₖ-L₃-X″ₘ₂ formula (3)
(wherein Rf″ represents a perfluoroalkyl group having 1 to 4 carbon atoms; (PFC) represents a perfluorocycloalkylene group; Y₂ represents a linking group containing an oxygen atom or a nitrogen atom; L₃ represents a simple bond or a linking group; X″ represents an anionic group, a cationic group, a nonionic group, or a water-solubility-imparting polar group containing an amphoteric group; n2 represents an integer of 1 to 5; k represents an integer of 1 to 3; and m2 represents an integer of 1 to 5).

3. A thermal transfer recording medium according to claim 1, wherein the release layer contains at least one selected from polyvinyl acetal and polyvinyl butyral.
